(19) United States
(12) Patent Application Publication
(10) Pub. No.: US 2016/0048362 A1
(43) Pub. Date: Feb. 18, 2016

(54) PROGRAMMABLE DISPLAY DEVICE

(71) Applicant: MITSUBISHI ELECTRIC CORPORATION, Tokyo (JP)

(72) Inventor: Takeshi MIZUGUCHI, Tokyo (JP)

(73) Assignee: Mitsubishi Electric Corporation, Tokyo (JP)

(21) Appl. No.: 14/784,129

(22) PCT Filed: May 9, 2013
(86) PCT No.: PCT/JP2013/063062

§ 371 Date: Oct. 13, 2015

(51) Int. Cl. G06F 3/14; G06T 1/60; G05B 19/042

(52) U.S. Cl. CPC G06F 3/14; G05B 19/042; G06T 1/60; G05B 2219/25217

(57) ABSTRACT

A programmable display device includes a storage unit that stores therein profile data, in which information related to protocols for respective control devices is profiled; a communication unit that transmits and receives communication line data between the control devices; a communication-data analysis unit that generates, by synthesizing the communication line data and the profile data, synthesized information in which attribute signifying information that signifies attributes of respective pieces of data included in the communication line data, value signifying information that signifies values in the communication line data, and values in the communication line data are associated with each other; and a display unit that displays the synthesized information. The profile data is information defined as a data string of a format determined by protocols that are different for each of the control devices, the profile data not being software for performing data exchange.

### FIELD

The present invention relates to a programmable display device that is connected to a control device.

### BACKGROUND

In the industrial field of FA (Factory

Automation) and the like, a programmable display device is used that, while displaying information related to a control device such as a PLC (Programmable Logic Controller), manages the control device and performs setting thereof. As a communication I/F that connects a programmable display device and a control device, there are multiple types of communication I/Fs such as I/Fs using RS232/RS422/RS485 serial connections and Ethernet®.

Furthermore, among FA systems, there are systems that have a system configuration in which information related to multiple control devices is displayed on one programmable display device. The communication protocol used in such an FA system is unique to each of the control devices, and the programmable display device has incorporated therein software for the different protocols for each of the respective control devices.

For an FA system to operate normally, it is necessary to correctly set, for example, the parameters for the programmable display device and the control devices. When there is a problem with the setting of parameters and the like, the programmable display device cannot communicate with the control devices correctly, and thus information cannot be displayed on the programmable display device correctly. In such a case, the programmable display device displays, on a screen thereof, an alarm message indicating that the communication is abnormal. For example, in a case where there is no response from control devices, the programmable display device sometimes displays an alarm message such as “communication timeout”.

With conventional error analysis methods, although it is possible to display the fact that there is an abnormality in communication between a programmable display device and a control device, it is not possible to display information regarding details of a specific abnormality and the method for handling the abnormality. Therefore, when details of a specific abnormality and handling methods thereof are analyzed, it is necessary for a user to obtain the data being transmitted on a communication line via multiple types of communication I/Fs, analyze the obtained data, and examine the cause of the problem.

Specifically, first, in order to extract abnormal packet data from data on a communication line, a user checks the response packet data transmitted by a control device for the protocol specifications of the storage location where the results of a normal response or an abnormal response are stored. Thereafter, the user checks whether there is any packet data in which a value stored in the storage location is abnormal, and when there is such packet data, abnormal values are extracted from the data of all packets to which the control device is responding. Subsequently, the user checks, with reference to the protocol specifications, the specific meaning of the abnormal values stored in the packet data of an abnormal response. Further, after the details of the abnormality have been determined, the user checks, with reference to the protocol specifications, whether data that has been transmitted by the programmable display device is normal. When the data that has been transmitted by the programmable display device is abnormal, the user checks whether the setting of the programmable display device is normal.

There is a type of conventional programmable display device that obtains data being transmitted along a serial communication line or an Ethernet® communication line using the software or hardware of a PC (Personal Computer) and then displays the obtained data. For example, there is a type of programmable display device that, when it uses an Ethernet® connection, separately displays header information and actual data portions in a general-purpose TCP, a general-purpose UDP, and the like.

However, with this type of programmable display device, the unique protocol parts of each of the control devices are merely displayed as data strings. Therefore, it is necessary for a user to perform error analysis by collating obtained data on a communication line and protocol specifications of the respective control devices, but such error analysis takes a very long time. Further, in an environment such as a clean room, where PCs cannot be used, it is very difficult to perform such error analysis.

Furthermore, when a plurality of programmable display devices and a plurality of control devices are communicating with each other, packet data (transmission and reception data) from these devices exists on a communication line in a mixed manner, so it takes a very long time to extract abnormal communication data from a large amount of data and to then analyze it.

The display device described in Patent Literature 1 includes a storage unit, which stores therein a code indicating an present position of data indicating what the operation of a programmable controller is and information related to a name allocated to the code while the code and the information being associated with each other, and a display unit, which displays the data as name information stored in the storage unit.

### CITATION LIST

### Patent Literature

Patent Literature 1: Japanese Patent Application Laid-open No. 2000-242306

### SUMMARY

### Technical Problem

With the conventional technique described above, when protocols are different for each one of the control devices, there has been a problem in that error analysis of the respective control devices cannot be performed by using communication line data.

The present invention has been achieved in view of the above problem, and an objective of the present invention is to provide a programmable display device that can easily perform error analysis on each one of the control devices even when protocols are different for the respective control devices.

### Solution to Problem

In order to solve the problem and achieve the objective mentioned above, the present invention relates to a programmable display device that includes a storage unit that stores therein profile data, in which information related to protocols for respective control devices is profiled; a communication unit that transmits and receives communication line data between the control devices; an analysis unit that generates, by synthesizing the communication line data and the profile data, synthesized information in which attribute signifying information that signifies attributes of respective pieces of data included in the communication line data, value signifying information that signifies a value in the communication line data, and a value in the communication line data are associated with each other; and a display unit that displays the synthesized information. The profile data is information defined as a data string of a format determined by protocols different for each of the control devices, the profile data not being software for performing data conversion.

### Advantageous Effects of Invention

According to the present invention, even when protocols are different for each one of the control devices, error analysis of the respective control devices can be easily performed.

### BRIEF DESCRIPTION OF DRAWINGS

FIG. 1 is a diagram illustrating a configuration of a control system including programmable display devices according to an embodiment.

FIG. 2 is a block diagram illustrating a configuration of the programmable display device according to the embodiment.

FIG. 3 is a diagram illustrating an example of data displayed using software for displaying general communication line data used by a PC.

FIG. 4 is a flowchart illustrating the procedure of a process for generating transmission data with reference to a device protocol profile and for transmitting the generated data.

FIG. 5 is a flowchart illustrating the procedure of a process for analyzing reception data with reference to a device protocol profile and then displaying the analyzed data.

FIG. 6 is a flowchart illustrating the procedure of a process for synthesizing both communication line data and a device protocol profile and for then displaying the synthesized information.

FIG. 7 is a diagram illustrating a first example of information containing synthesized profile data and communication line data.

FIG. 8 is a diagram illustrating a second example of information containing synthesized profile data and communication line data.

FIG. 9 is a diagram illustrating a third example of information containing synthesized profile data and communication line data.

### DESCRIPTION OF EMBODIMENTS

Exemplary embodiments of a programmable display device according to the present invention will be explained below in detail with reference to the accompanying drawings. The present invention is not limited to the embodiments.

### Embodiment

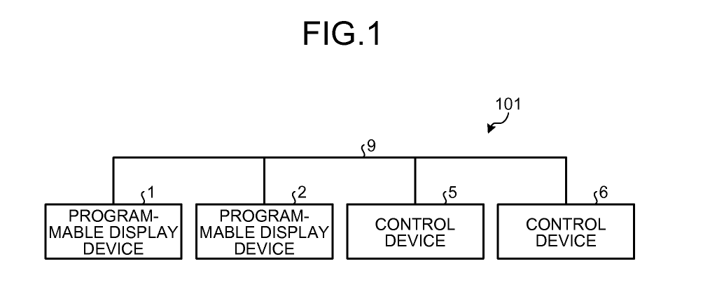

FIG. 1 is a diagram illustrating a configuration of a control system including programmable display devices according to an embodiment. A control system 101 includes M (M is a natural number) programmable display devices having a communication diagnosis function; N (N is a natural number) control devices having a communication function; and a communication line 9. The programmable display devices and the control devices are connected to each other via the communication line 9. With this configuration, in the control system 101, a communication configuration is established between M programmable display devices and N control devices.

In the present embodiment, a case where the control system 101 includes programmable display devices 1 and 2 and control devices 5 and 6 is described. Each of the programmable display devices 1 and 2 communicates with the control devices 5 and 6; displays information related to the control devices 5 and 6; and performs operations with respect to the control devices 5 and 6. With this configuration, the programmable display devices 1 and 2 manage the control devices 5 and 6 and perform setting of the control devices 5 and 6, while displaying information related to the control devices 5 and 6. The control devices 5 and 6 are, for example, a PLC (Programmable Logic Controller), and they control the operations of a robot (not illustrated) and the like.

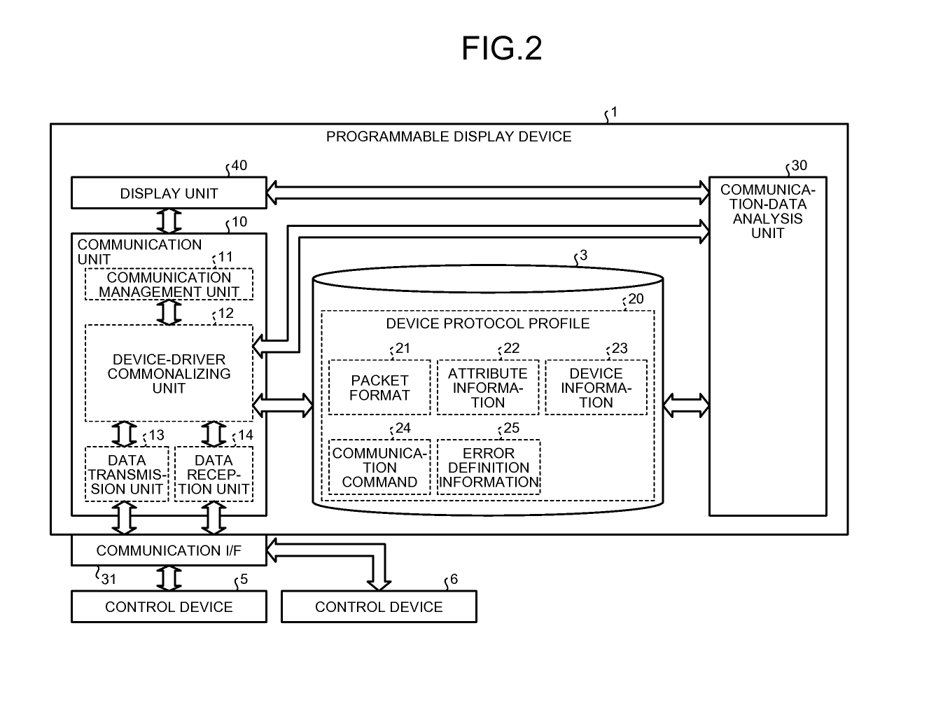

FIG. 2 is a block diagram illustrating a configuration of the programmable display device according to the embodiment. Because the programmable display devices 1 and 2 have an identical configuration, only the programmable display device 1 is described here.

The programmable display device 1 includes the following hardware: a communication unit 10; a display unit 40; a storage unit 3 that stores therein a device protocol profile 20; a communication-data analysis unit 30; and a communication I/F (interface) 31.

The communication unit 10 is connected to the display unit 40, the communication-data analysis unit 30, and the storage unit 3. The communication unit 10 performs transmission and reception of data between the control devices 5 and 6 via the communication I/F 31. The communication unit 10 is software that is not dependent on the control devices 5 and 6, which are analysis targets, and it is commonly used with the control devices 5 and 6.

A communication management unit 11 performs scheduling of individual communication-related blocks. The communication unit 10 includes the communication management unit 11, a device-driver commonalizing unit 12, a data transmission unit 13, and a data reception unit 14. The communication management unit 11, the data transmission unit 13, and the data reception unit 14 are each connected to the device-driver commonalizing unit 12. The device-driver commonalizing unit 12 is also connected to the communication-data analysis unit 30 and the storage unit 3.

The device-driver commonalizing unit 12 reads protocol specifications of the control devices 5 and 6 from the device protocol profile 20 in the storage unit 3, and it then generates communication line data (transmission packet data) to be transmitted to the control devices 5 and 6. Further, the device-driver commonalizing unit 12 functions as a communication I/F between the communication unit 10 and the communication-data analysis unit 30. The device-driver commonalizing unit 12 reads response data (communication line data) transmitted from the control devices 5 and 6, and it then extracts data from the transmitted data. The device-driver commonalizing unit 12 transmits the extracted data to the communication management unit 11.

The data transmission unit 13 transmits communication line data generated in the device-driver commonalizing unit 12 to the control devices 5 and 6 via the communication I/F 31. The data reception unit 14 receives response data transmitted from the control devices 5 and 6 via the communication I/F 31. The data reception unit 14 transmits the received response data to the device-driver commonalizing unit 12.

The display unit 40 displays information acquired from the control devices 5 and 6. The communication I/F 31 is implemented by multiple types of communication I/Fs such as I/Fs using RS232/RS422/RS485 serial connections and Ethernet®.

The device protocol profile 20, generated as information (protocol information) related to communication protocols unique to each of the control devices 5 and 6, is generated as profile data (profile data) instead of being generated as a source code. In this manner, the programmable display device 1 stores therein different protocol information for each of the control devices 5 and 6 as the device protocol profile 20, without having incorporated therein the protocol information as software for performing data conversion.

The device protocol profile 20 is profile data in which information related to protocols for each of the control devices 5 and 6 is profiled. The device protocol profile 20 is defined as a data string of a format determined by communication protocols respectively for each of the control devices 5 and 6. The device protocol profile 20 is configured to include a packet format 21, attribute information 22, device information 23, a communication command 24, and error definition information 25.

The packet format 21 is information related to a format of communication line data (packet data) determined by the communication protocols for the control devices 5 and 6. The packet format 21 includes a format of communication line data to be transmitted from the programmable display device 1 to the control devices 5 and 6 and a format of communication line data to be used when the control devices 5 and 6 respond to the transmitted data.

The attribute information 22 is information indicating attributes of respective data strings included in communication line data. The attribute information 22 includes attributes of communication line data to be transmitted from the programmable display device 1 to the control devices 5 and 6 and attributes of communication line data to be used when the control devices 5 and 6 respond to the transmitted data.

Among the communication protocols, there are protocols that set, in respective communication devices, an attribute (device identification information) for uniquely specifying (identifying) a communication device such as the programmable display devices 1 and 2 and the control devices 5 and 6 in the control system 101. Such device identification information is, for example, a network number or a station number. In the present embodiment, such device identification information is included in communication line data and the attribute information 22. With this configuration, when error analysis is performed, the device-driver commonalizing unit 12 becomes capable of easily extracting only communication line data as an analysis target to be transmitted from the control devices 5 and 6.

The device information 23 is information related to devices included in the control devices 5 and 6. In the device information 23, for example, an actual device name, information for identifying devices, and a device address are associated with each other. The information for identifying devices and the device address can be the same data.

The communication command 24 is a command that is used during the communication. The types of the communication command 24 includes, for example, a continuous device acquisition command (a continuous read command) that is used when data acquisition is performed for a device (such as a data register) in which addresses are continuous, and a random device acquisition command that is used when data acquisition is performed for a device in which addresses are discontinuous.

The error definition information 25 is information related to errors. The error definition information 25 includes error position information in which a position of storing error information (an error code) within response data (communication line data as packet data) to be transmitted from the control devices 5 and 6 is defined. The error definition information 25 further includes error association information in which an error code and error details are associated with each other.

The communication-data analysis unit 30 collects, displays, and analyses (diagnoses) communication line data transmitted and received between the control devices 5 and 6. Specifically, the communication-data analysis unit 30 analyzes, using the device protocol profile 20, communication line data acquired from the control devices 5 and 6.

The communication-data analysis unit 30 is software that is used without depending on protocols and used in common to the respective protocols. The communication-data analysis unit 30 according to the present embodiment collates received communication line data with the device protocol profile 20, divides the communication line data into data strings for respective attributes, and recognizes the divided pieces of the communication line data.

Furthermore, the communication-data analysis unit 30 synthesizes the device protocol profile 20 with communication line data having been transmitted and received between the control devices 5 and 6 so as to generate information to be displayed on the display unit 40. With this configuration, the communication-data analysis unit 30 causes the display unit 40 to display thereon information (such as data (error data) indicating an abnormal value) indicating whether data included in communication line data on a communication line is abnormal. In this manner, the communication-data analysis unit 30 according to the present embodiment performs analysis of communication line data by synthesizing the device protocol profile 20 and communication line data.

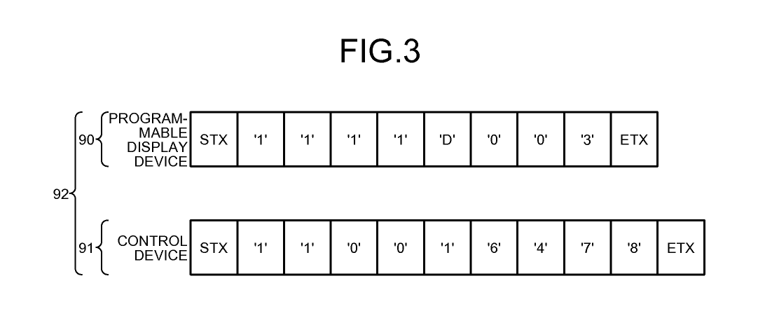

Next, software for displaying general communication line data (communication-line-data display software) that is used by a PC (Personal Computer) and the like is described. FIG. 3 is a diagram illustrating an example of data displayed using software for displaying general communication line data used by a PC.

The communication-line-data display software displays data 90 having been transmitted by the programmable display device 1 and response data 91 having been responded by the control devices 5 and 6 as a data string group 92; however, the communication-line-data display software does not display the meaning of respective data strings. Therefore, when error analysis is performed, it is necessary that a user performs the error analysis while collating displayed data strings on a communication line with protocol specifications of each of the control devices 5 and 6. As for hardware included in a conventional PC, similarly to the communication-line-data display software, the meaning of data strings is not displayed.

In the present embodiment, the communication-data analysis unit 30 performs, as a data analysis process, generation of information to be displayed on the display unit 40, by synthesizing profile data (the device protocol profile 20) and communication line data (transmission and reception data).

For example, with respect to a data string indicated as “44” in communication line data, the communication-data analysis unit 30 causes “44”, “error details”, and “format unmatched” to be associated with each other according to the device protocol profile 20, and displays these items. With this configuration, a user can easily recognize that the error code “44” of “format unmatched” is included in the communication line data.

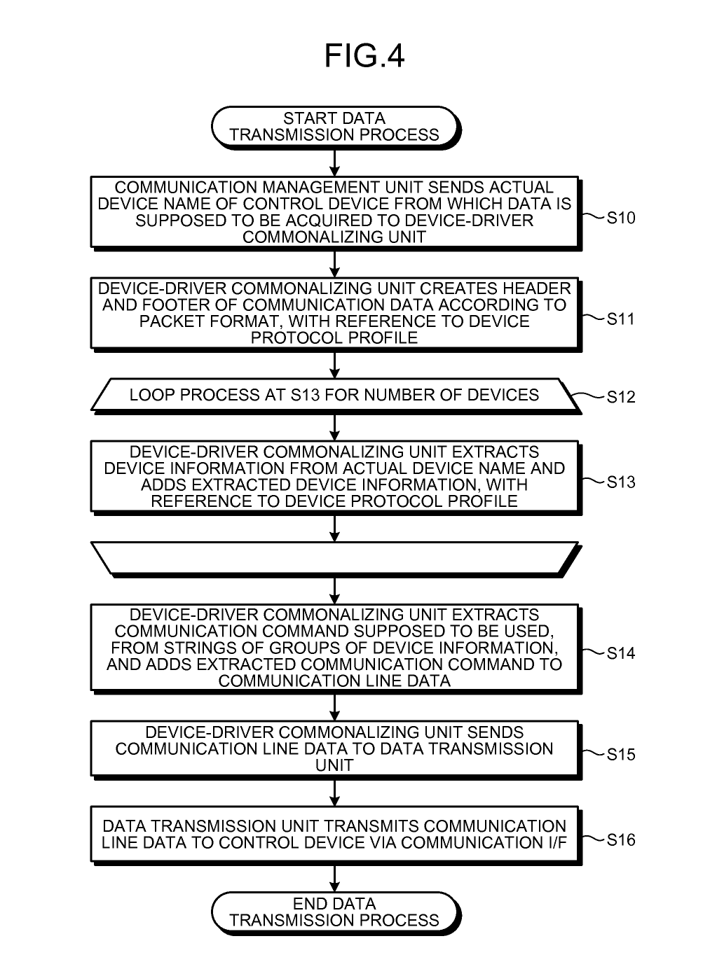

Next, the process of the procedure for a process for generating transmission data with reference to the device protocol profile 20 is described. FIG. 4 is a flowchart illustrating the procedure of a process for generating transmission data with reference to a device protocol profile and for transmitting the generated data. In this example, a case where the programmable display device 1 transmits communication line data to the control device 5 is described.

Among the data acquired by the programmable display device 1 from the control device 5, as for actual device names such as “data register”, names created by a user using engineering software that is generally operated on a PC are downloaded in advance in the programmable display device 1. In the programmable display device 1, actual device names are stored in the communication management unit 11.

The communication management unit 11 sends an actual device name of a control device (a data acquisition target) from which data is supposed to be acquired to the device-driver commonalizing unit 12 (Step S10). The device-driver commonalizing unit 12 creates a header and a footer according to the control device 5 of a corresponding packet, with reference to the device protocol profile 20 and according to the packet format 21 (Step S11). The header and the footer are defined by protocols for respective ones of the control device 5, and are not dependent on an actual device name set by the user.

The device-driver commonalizing unit 12 repeats the following process at Step S13 for the number of devices on which data analysis is performed (Step S12). The device-driver commonalizing unit 12 refers to the device protocol profile 20, extracts the device information 23 from an actual device name, and adds the extracted device information 23 between a header and a footer of a communication line data (Step S13). In other words, the device-driver commonalizing unit 12 extracts certain device information 23 that is associated with an actual device name from plural pieces of the device information 23, and adds the extracted device information 23 between the header and the footer.

The device-driver commonalizing unit 12 extracts the communication command 24 that is supposed to be used, from strings (addresses) of groups of the device information 23, and adds the extracted communication command 24 to a communication line data (Step S14). At this point, for example when there is a data register in which addresses are continuous in the strings of groups of the device information 23, the device-driver commonalizing unit 12 extract a continuous device acquisition command as the communication command 24. Subsequently, the device-driver commonalizing unit 12 uses the continuous device acquisition command for the communication command 24.

Furthermore, when the strings (addresses) of groups of the device information 23 are discontinuous and intermittent, the device-driver commonalizing unit 12 extracts a random device acquisition command as the communication command 24. Subsequently, the device-driver commonalizing unit 12 uses the random device acquisition command for the communication command 24.

The device-driver commonalizing unit 12 sends communication line data, in which a header, a footer, the device information 23, and the communication command 24 are set, to the data transmission unit 13 (Step S15). Subsequently, the data transmission unit 13 transmits the communication line data to the control device 5 via the communication I/F 31 (Step S16).

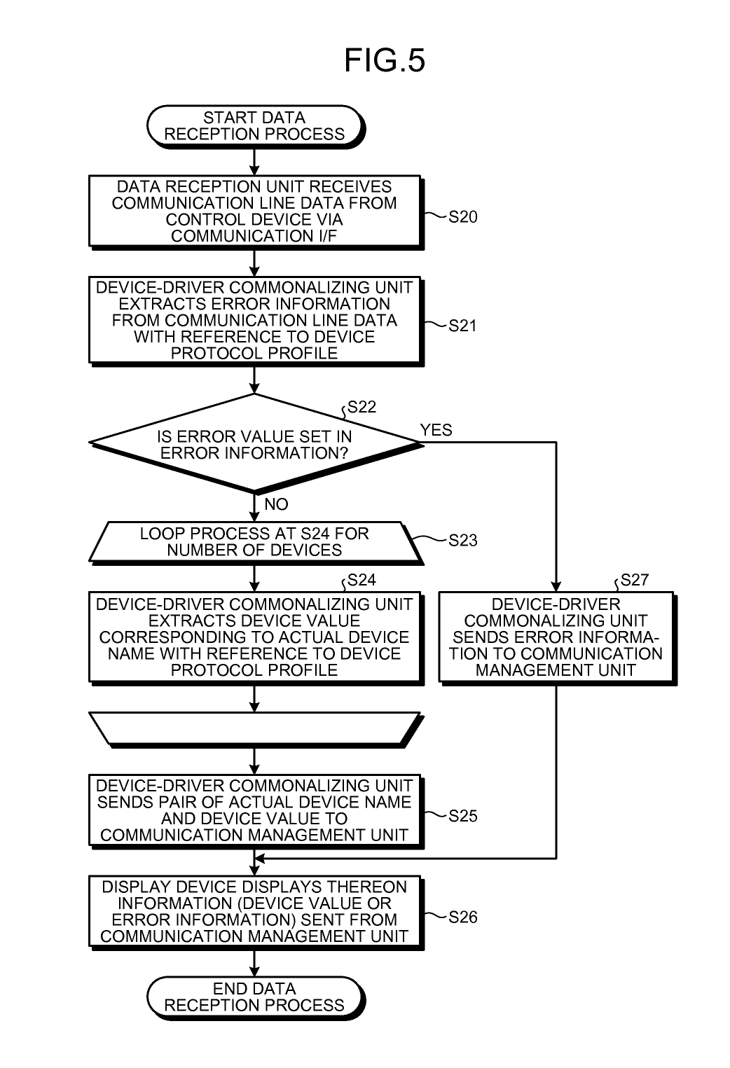

Next, the procedure of a process for analyzing reception data with reference to the device protocol profile 20 is described. FIG. 5 is a flowchart illustrating the process of a process for analyzing reception data with reference to a device protocol profile and then displaying the analyzed data. In this example, a case where the programmable display device 1 receives data from the control device 5 is described.

The data reception unit 14 receives communication line data from the control device 5 via the communication I/F 31 (Step S20). The data reception unit 14 sends the received communication line data to the device-driver commonalizing unit 12.

Thereafter, the device-driver commonalizing unit 12 refers to the device protocol profile 20. The error definition information 25 in which a position of error information on communication line data is defined is stored in the device protocol profile 20. Accordingly, the device-driver commonalizing unit 12 extracts error information (an error code) from the communication line data on the basis of the error definition information 25 (Step S21).

When an error value is not set in the error information (NO at Step S22), the device-driver commonalizing unit 12 repeats the following process at Step S24 for the number of devices (Step S23). The device-driver commonalizing unit 12 extracts a device value corresponding to an actual device name on the basis of the device protocol profile 20 (Step S24). The device-driver commonalizing unit 12 sends a pair of the actual device name and the device value to the communication management unit 11 (Step S25).

Meanwhile, when an error value is set in the error information (YES at Step S22), the device-driver commonalizing unit 12 sends the error information to the communication management unit 11 (Step S27). Subsequently, the communication management unit 11 causes the display unit 40 to display thereon the device value or the error information sent from the communication management unit 11 (Step S26). By synthesizing communication line data and the device protocol profile 20, the programmable display device 1 displays the meaning of the error information and the like with the error information and the like.

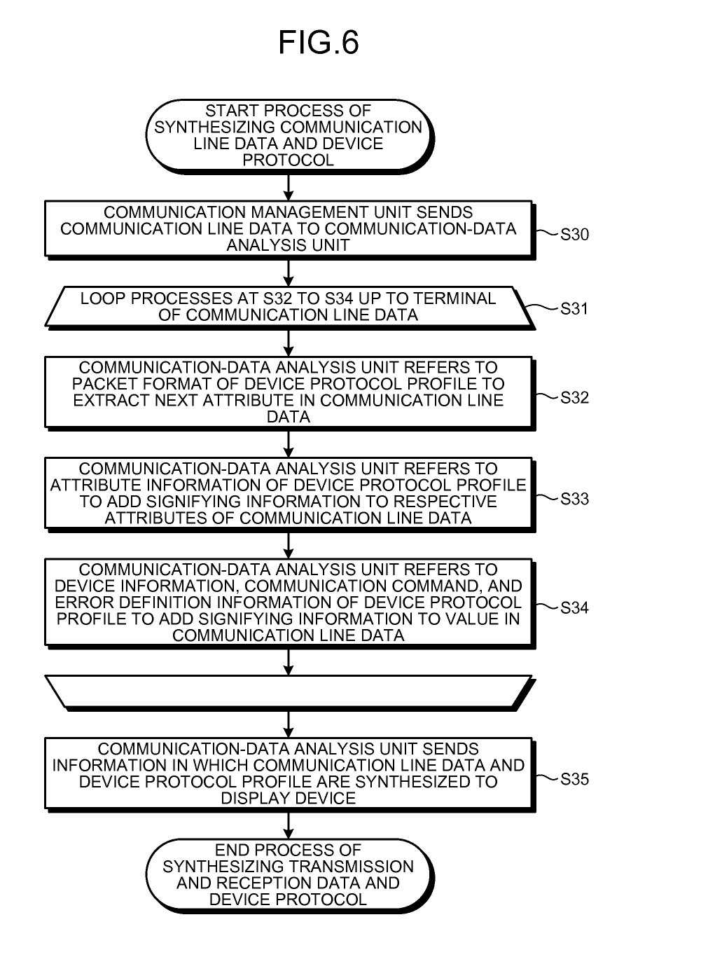

Next, the procedure of a process for synthesizing communication line data and the device protocol profile 20 is described. FIG. 6 is a flowchart illustrating the procedure of a process for synthesizing communication line data and a device protocol profile and for then displaying the synthesized information. In this example, a case where the programmable display device 1 synthesizes communication line data and the device protocol profile 20 is described.

The communication management unit 11 sends communication line data to the communication-data analysis unit 30 (Step S30). The communication-data analysis unit 30 repeats the processes at Steps S32 to S34 from the first attribute to the last attribute of the communication line data (Step S31).

The communication-data analysis unit 30 refers to the packet format 21 of the device protocol profile 20 to extract a next attribute in the communication line data (Step S32). Subsequently, the communication-data analysis unit 30 refers to the attribute information 22 of the device protocol profile 20 to add information (signifying information) related to the meaning of respective attributes to the attributes of the communication line data (Step S33).

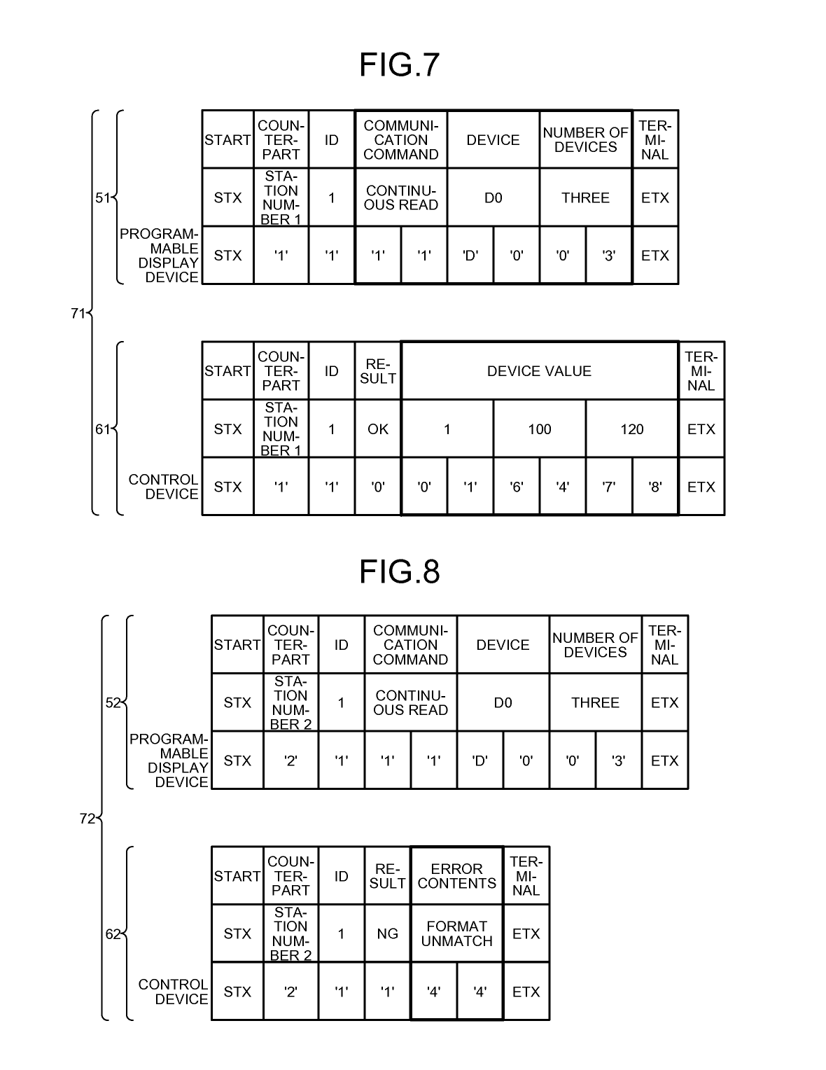

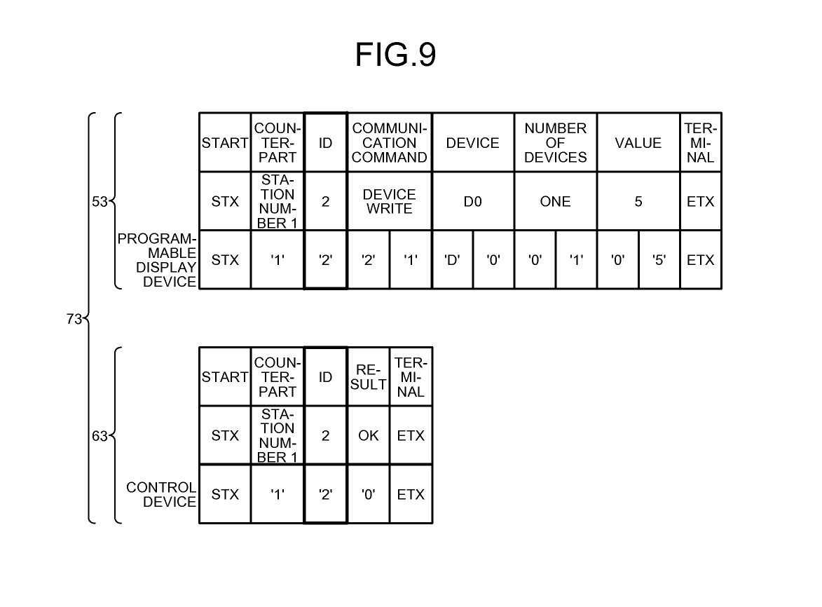

With reference to FIGS. 7 to 9, specific examples of a process for analyzing communication line data by synthesizing the device protocol profile 20 (profile data) and the communication line data is described here. FIG. 7 is a diagram illustrating a first example of information containing synthesized profile data and communication line data. FIG. 8 is a diagram illustrating a second example of information containing synthesized profile data and communication line data. FIG. 9 is a diagram illustrating a third example of information containing synthesized profile data and communication line data.

FIG. 7 illustrates post-synthesis communication line data 71, which is a pair of transmission data 51 having been transmitted from the programmable display device 1 to the control device 5 and reception data 61 that is response data from the control device 5 to the transmission data 51.

FIG. 8 illustrates post-synthesis communication line data 72, which is a pair of transmission data 52 having been transmitted from the programmable display device 1 to the control device 6 and reception data 62 that is response data from the control device 6 to the transmission data 52.

FIG. 9 illustrates post-synthesis communication line data 73, which is a pair of transmission data 53 having been transmitted from the programmable display device 1 to the control device 5 and reception data 63 that is response data from the control device 5 to the transmission data 53.

The device protocol profile 20 is information at, in each one of protocols, the uppermost tier and the middle tier of the transmission data 51 to the transmission data 53 and of the reception data 61 to the reception data 63. The communication line data is information at the lowermost tier of the transmission data 51 to the transmission data 53 and of the reception data 61 to the reception data 63. Synthesized information in which the communication line data and the device protocol profile 20 are synthesized is, for example, the post-synthesis communication line data 71 to the post-synthesis communication line data 73 illustrated in FIGS. 7 to 9, respectively.

By synthesizing acquired communication line data (packet data) on a communication line and the device protocol profile 20 (profile data), the communication-data analysis unit 30 synthesizes signifying information of each attribute for every data string of the communication line data. With this configuration, it becomes possible to display each data string of the communication line data and attributes while these attributes and data strings are associated with each other.

Signifying information of every attribute (hereinafter, “attribute signifying information”) is information at the uppermost tier of the transmission data 51 to the transmission data 53 and of the reception data 61 to the reception data 63. The attribute signifying information is information (such as an attribute name) signifying what the data (the value) in these attributes is. The attribute signifying information is, for example, sections of “start”, “counterpart”, “ID”, “communication command”, “device”, “number of devices”, and “terminal” in the transmission data 51.

Next, the communication-data analysis unit 30 refers to the device information 23, the communication command 24, and the error definition information 25 of the device protocol profile 20 so as to add signifying information for every value (hereinafter, “value signifying information”) to the data value in the transmission data 51 to the transmission data 53 and of the reception data 61 to the reception data 63 (Step S34). The value signifying information is information at the middle tier of the transmission data 51 to the transmission data 53 and of the reception data 61 to the reception data 63. The value signifying information is, for example, sections of “STX”, “station number 1”, “1”, “continuous read”, “D0”, “three”, and “ETX” in the transmission data 51.

In this manner, by synthesizing communication line data and the device protocol profile 20, the communication-data analysis unit 30 generates synthesized information (the post-synthesis communication line data 71 to the post-synthesis communication line data 73) in which attribute signifying information, value signifying information, and a data value are associated with each other for every attribute.

When the process for synthesizing communication line data and the device protocol profile 20 up to the terminal of the communication line data is completed by repeating the processes at Steps S32 to S34, the communication-data analysis unit 30 sends information (such as the post-synthesis communication line data 71 to the post-synthesis communication line data 73), in which profile data and communication line data are synthesized, to the display unit 40. The display unit 40 then displays the post-synthesis communication line data 71 to the post-synthesis communication line data 73 and the like (Step S35).

For example, in the post-synthesis communication line data 71, “communication command” in the attribute signifying information, “continuous read” in the value signifying information, and the data value “11” are associated with each other. Therefore, it is indicated that, in the post-synthesis communication line data 71, a continuous read command of the command number “11” has been sent from the programmable display device 1 to the control device 5.

Furthermore, in the post-synthesis communication line data 71, “device” in the attribute signifying information, “D0” in the value signifying information, and the data value “D0” are associated with each other. Therefore, it is indicated that, in the post-synthesis communication line data 71, a data acquisition process has been performed on a device with an actual device name of “D0”.

Further, in the post-synthesis communication line data 71, “device value” in the attribute signifying information, “100” in the value signifying information, and “64” in the data value (the device value) are associated with each other. Therefore, it is indicated that, in the post-synthesis communication line data 71, “100” (“64” in hexadecimal) of the device value has been sent from the control device 5 to the programmable display device 1.

For example, because the post-synthesis communication line data 71 is displayed, a user can easily recognize that the device value corresponding to the actual device name “DO” is “1” (“01” in hexadecimal), the device value corresponding to the actual device name “D1” is “100” (“64” in hexadecimal), and the device value corresponding to the actual device name “D2” is “120” (“78” in hexadecimal).

When the numerical value displayed on the programmable display device 1 is an abnormal value, by checking the post-synthesis communication line data 71 to the post-synthesis communication line data 73, the user can easily recognize which one of the transmission data from the programmable display device 1, the response data (the reception data) from the control devices 5 and 6, and display control of the programmable display device 1 has a problem.

For example, in the reception data 61 illustrated in FIG. 7, when the device value and the like is an abnormal value, it is sufficient that a user checks devices and the like of the transmission data 51. For example, in a case where the user is supposed to set an actual device name of “D100”, if the user has mistakenly set “D0” as the actual device name, the user easily recognize the mistake on the device name setting as the transmission data 51 is checked. In this manner, the user can easily recognize abnormality positions only by causing the programmable display device 1 to display the post-synthesis communication line data 71.

Furthermore, when the programmable display device 1 cannot communicate with the control device 6, for example, an alarm is displayed on the programmable display device 1. In this case, conventionally, it has been difficult to also display error details corresponding to an error response from the control device 6 on the programmable display device 1.

In the post-synthesis communication line data 72 illustrated in FIG. 8, because the position, value, and meaning in an error response from the control device 6 are displayed at the same time, it is possible to easily clarify the details of communication errors.

For example, if the user forgets to match the communication format of the programmable display device 1 to the communication format of the control device 6 as in the post-synthesis communication line data 72, “error details” in the attribute signifying information, “format unmatched” in the value signifying information, and “44” of the error code are associated with each other and displayed. Therefore, the user can directly recognize that, on the basis of the displayed post-synthesis communication line data 72, the error is caused by the format unmatched of these communication formats.

Furthermore, it is possible to configure that the error definition information 25 defined in the device protocol profile 20 includes estimation factors (causes) of errors and processing details (handling methods) with respect to the errors. For example, the communication-data analysis unit 30 causes error details in communication line data and at least either of estimation factors (causes) of errors and processing details (handling methods) with respect to the errors to be associated with each other, and information in which these pieces of data are associated with each other is displayed on the display unit 40.

With this configuration, even when a communication abnormality has occurred, it is possible to easily display estimated causes of errors and processing details thereof on the programmable display device 1.

Accordingly, the user can further easily recognize the method for solving the error causes.

Further, when a plurality of the programmable display devices 1 and 2 and a plurality of the control devices 5 and 6 are communicating with each other, transmission data and reception data are present in a mixed manner. Therefore, conventionally, extraction of communication line data as a data analysis target has been laborious. Among communication protocols, there are protocols that add an ID to communication data (a packet) being communicated between the programmable display devices 1 and 2 and the control devices 5 and 6. This ID (device identification information) is, for example, information that is incremented each time a packet is transmitted. Therefore, in the present embodiment, it is possible to configure that an ID for uniquely specifying communication line data is embedded in the communication line data, and the ID is defined in the device protocol profile 20. For example, information indicating an associating relation between an ID and the control devices 5 and 6 is included in the device protocol profile 20.

With this configuration, when communication line data is analyzed, it becomes easy to extract a pair of pieces of communication line data that has been transmitted and received by a programmable display device and a control device, where the pair is specified by a user. For example, the communication-data analysis unit 30 can easily extract, from communication line data, transmission data and reception data in which the values of IDs thereof match each other, such as the post-synthesis communication line data 73. As a result, because transmission data and reception data as an analysis target can be easily displayed on the programmable display device 1, the user can easily recognize information related to errors.

As described above, in the programmable display device 1, protocol information different for each of the control devices 5 and 6 is defined as the device protocol profile 20, without having the protocol information incorporated in the programmable display device 1 as software.

Furthermore, in the programmable display device 1, the communication unit 10 and the communication-data analysis unit 30 are provided independently, and as software of respective units refers to the device protocol profile 20, the communication between the control devices 5 and 6 is performed, and collection, analysis, and display of communication line data are also performed. When the display of the communication line data is performed, by synthesizing acquired communication line data and the device protocol profile 20, the programmable display device 1 synthesizes the meaning of respective attributes for each data of the communication line data and displays the synthesized information.

Communication line data on a communication line continuously flows during the programmable display device 1 is operated. Therefore, when there are stringent memory restrictions, a memory on the programmable display device 1 can be used as a ring buffer. In this case, the programmable display device 1 displays communication line data in the time periods before and after defined by a trigger condition set in advance or displays communication line data in the time period specified by a user. Further, it is possible to configure that the programmable display device 1 converts a result of analysis performed by the communication-data analysis unit 30 into a text format or a CSV format displayable on a PC and the like, and outputs the converted result to an external device.

As described above, according to the present embodiment, acquisition, display, and analysis of information of troubles in communication line data occurred during connecting and activating the control devices 5 and 6 or during operating these devices can be performed only by the programmable display device 1, without using any external device (load facility) such as a PC. With this configuration, a trouble related to communication between the programmable display device 1 and the control devices 5 and 6 can be solved promptly at the site of error occurrence. Further, displayed is information in which the meaning of each attribute of respective pieces of data of communication line data, specific transmission data and reception data in question, estimated causes and processing details conceived on the basis of the result of analysis, and the like are displayed on the programmable display device 1; so that it is possible to detect abnormality causes and to apply countermeasures for these causes more easily than a case where an external device such as a PC is used. Therefore, even in a case where protocols are different for each one of control devices, error analysis of the respective control devices can be easily performed.

### INDUSTRIAL APPLICABILITY

As described above, the programmable display device according to the present invention is suitable for analyzing communication abnormalities.

### REFERENCE SIGNS LIST

1, 2 programmable display device, 3 storage unit, 5, 6 control device, 10 communication unit, 11 communication management unit, 12 device-driver commonalizing unit, 13 data transmission unit, 14 data reception unit, 20 device protocol profile, 21 packet format, 22 attribute information, 23 device information, communication command, 25 error definition information, 30 communication-data analysis unit, 31 communication I/F, display unit, 51 to 53 transmission data, 61 to 63 reception data, 71 to 73 post-synthesis communication line data, 101 control system.

1. A programmable display device comprising:
a storage unit that stores therein profile data, in which information related to protocols for respective control devices is profiled;
a communication unit that transmits and receives communication line data between the control devices;
an analysis unit that generates, by synthesizing the communication line data and the profile data, synthesized information in which attribute signifying information that signifies attributes of respective pieces of data included in the communication line data, value signifying information that signifies a value in the communication line data, and a value in the communication line data are associated with each other; and
a display unit that displays the synthesized information, wherein
the profile data is information defined as a data string of a format determined by protocols different for each of the control devices,
the profile data not being software for performing data conversion.

2. The programmable display device according to claim 1, wherein
the profile data includes attribute information indicating attributes of respective data strings stored in the communication line data, and
the analysis unit
divides the communication line data into data strings of different attributes on the basis of the attribute information, and
generates the synthesized information for each of the divided data strings.

3. The programmable display device according to claim 1, wherein
the display unit displays
transmission data that has been transmitted from the communication unit to the control device and
reception data that has been transmitted from the control device as response data in response to the transmitted data and received by the communication unit, the transmission data and the reception data being displayed as a pair of communication line data that are combined with the transmission data and the reception data.

4. The programmable display device according to claim 1, wherein
the communication line data includes device identification information for identifying a control device that transmits and receives the communication line data,
the profile data includes information for indicating an associative relation between the device identification information and the control device,
the communication unit extracts communication line data specified by a user on the basis of the device identification information and the profile data, and
the analysis unit generates the synthesized information using extracted communication line data.

5. The programmable display device according to claim 1, wherein
the profile data includes error definition information in which an error code used in the communication line data and at least one of error details, estimation factors of an error, and processing details with respect to an error are associated with each other, and
the analysis unit, when error information related to an error is included in the communication line data, generates synthesized information in which the error information and at least one of the error details, the estimation factors of an error, and the processing details with respect to an error are associated with each other.
